(19) United States
(12) Patent Application Publication
(10) Pub. No.: US 2008/0169667 A1
(43) Pub. Date: Jul. 17, 2008

(54) UNIVERSAL ACCESSORY SYSTEM

(76) Inventors: ANDREW SINIARSKI, Windsor (CA); JAMES D. DOWD, Farmington Hills, MI (US)

Correspondence Address: BRINKS HOFER GILSON & LIONE, P.O. BOX 10395, CHICAGO, IL, 60610, US

(21) Appl. No.: 11/972,836

(22) Filed: Jan. 11, 2008

Related U.S. Application Data
(60) Provisional application No. 60/884,491, filed on Jan. 11, 2007.

(51) Int. Cl. B60R 7/04

(52) U.S. Cl. 296/37.8

(57) ABSTRACT

A universal accessory attachment system for the interior of a vehicle is designed to connect any one or more of a variety of accessories to various vehicle panels within a vehicle. The attachment system includes an accessory having a male connector configured to selectively attach the accessory to a vehicle panel located within the vehicle. The vehicle panel defines a female connector sized and shaped to receive the male connector. The male connector of the accessory cooperates with the female connector within the vehicle to selectively attach the accessory within the vehicle.

### CROSS-REFERENCE TO RELATED APPLICATIONS

This application claims the benefit of U.S. Provisional Application Ser. No. 60/884,491 filed on Jan. 11, 2007, entitled “UNIVERSAL ACCESSORY SYSTEM,” the entire contents of which are incorporated herein by reference.

### BACKGROUND OF THE INVENTION

1. Field of the Invention

The present invention generally relates to vehicle accessories for automotive interiors, and more particularly, to a universal accessory system for interchangeably attaching a variety of accessories for use within the interior of a vehicle.

2. Description of Related Art

Passenger vehicles may include a variety of accessories such as sunglass holders, CD holders, hooks, trays, and the like for conveniently storing various items within the vehicle interior compartment. Typically, such accessories are permanently attached to a structural portion of the vehicle, whereby installation of accessory options is generally conducted in a factory setting during vehicle construction. This often requires user acceptance of preinstalled option packages or user-selection of the desired articles prior to vehicle assembly. Such accessories or components are commonly attached directly to a particular position on the vehicle structure.

### BRIEF SUMMARY OF THE INVENTION

One embodiment of the present invention provides an accessory attachment system for the interior of a vehicle. The accessory attachment system comprises an accessory having a male connector adapted to attach the accessory to a vehicle panel located within the interior of the vehicle. The vehicle panel defines a female connector sized and shaped to receive the male connector. The male connector cooperates with the female connector to selectively attach the accessory within the vehicle. Preferably, a plurality of female connectors is provided on a vehicle panel within the vehicle interior, allowing customization of the interior. A variety of interchangeable accessories can be selectively attached and removed within the interior of a vehicle in accordance with the consumer's work, travel, or hobby preferences.

Another embodiment of the present invention provides an accessory attachment system for the interior of a vehicle having an accessory including a male connector adapted to attach the accessory to a vehicle panel within the interior of the vehicle. The vehicle panel has a first surface exposed to the interior of the vehicle and a female connector is formed within the vehicle panel such that the accessory attaches directly to the vehicle panel. The female connector is formed in a plane generally parallel to the first surface of the vehicle panel and is sized and shaped to receive the male connector. The male connector cooperates with the female connector to selectively attach the accessory within the vehicle.

The present invention provides the consumer with the flexibility to configure the interior differently for daily use or for trips. A variety of accessories such as hooks, trays, cup holders, sunglass holders, phone holders, and CD holders may be interchangeably secured to vehicle panels including instrument panels, center stack consoles, pillar trim panels, ceiling panels, and door panels.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of an accessory and a vehicle panel according to one embodiment of the attachment system of the present invention;

FIG. 2 is a perspective view of an accessory and a vehicle panel according to an alternative embodiment of the attachment system of the present invention;

FIG. 3 is a perspective view of an accessory and a vehicle panel according to an alternative embodiment of the attachment system of the present invention;

FIGS. 4a-d are perspective views of an accessory and a vehicle panel according to an alternative embodiment of the attachment system of the present invention;

FIG. 5 is a perspective view of an accessory attachable to a vehicle panel and a sub-accessory attachable to the accessory according to an embodiment of the attachment system of the present invention;

FIG. 6 is a cross sectional view of a vehicle panel according to one embodiment of the attachment system of the present invention.

FIG. 7 is a cross sectional view of a vehicle panel according to an alternative embodiment of the attachment system of the present invention.

FIGS. 8a-i are perspective views of various accessories according to alternative embodiments of the attachment system of the present invention; and

FIG. 9 is a perspective view of the interior of a vehicle including vehicle panels according to alternative embodiments of the attachment system of the present invention.

### DETAILED DESCRIPTION OF THE INVENTION

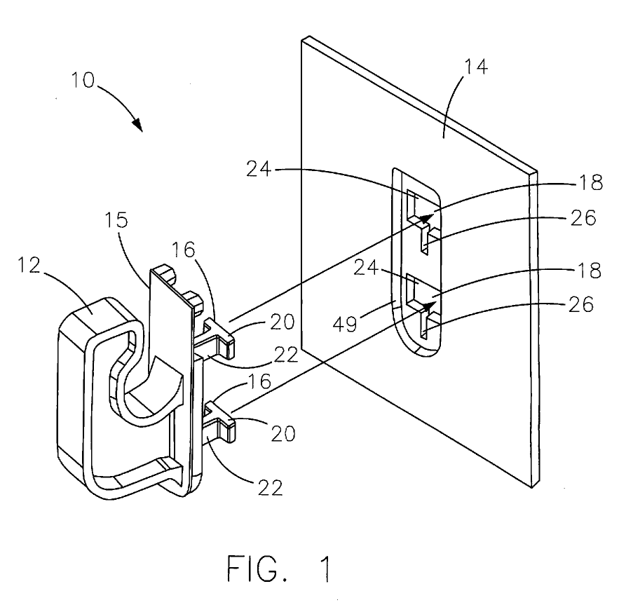

The present invention generally provides a universal accessory attachment system which provides virtually unlimited customization of an automotive interior space. Referring now to FIGS. 1-3, an accessory attachment system is illustrated and designated generally at 10. The accessory attachment system 10 includes an accessory 12 selectively attachable to a vehicle panel 14 located within the interior of a vehicle. The accessory attachment system 10 of the present invention allows a user to interchangeably mount a variety of different accessories 12 to various vehicle panels 14 within a vehicle.

The attachment of the accessory 12 to the vehicle panel 14 may occur through frictional engagement, deformable detents, or mating connectors. Generally, the accessory 12 includes a male connector 16 and the vehicle panel 14 includes a female connector 18 sized and shaped to receive the male connector 16. The male connector 16 cooperates with the female connector 18 to selectively attach the accessory 12 within the vehicle. For increased stability, a larger accessory 12 may include a plurality of male connectors 16 and the vehicle panel 14 may include a plurality of female connectors 18 configured to cooperate with the plurality of male connectors 16 to attach a larger accessory 12 within the vehicle interior. The male connector 16 and the corresponding female connector 18 may take any form that allows selective attachment and removal of an accessory 12. For example, FIGS. 1-3 show an accessory 12 having a male connector illustrated as a pair of tabs or prongs 16. The vehicle panel 14 includes a female connector illustrated as a pair of slots or apertures 18 sized and shaped to receive the prongs 16.

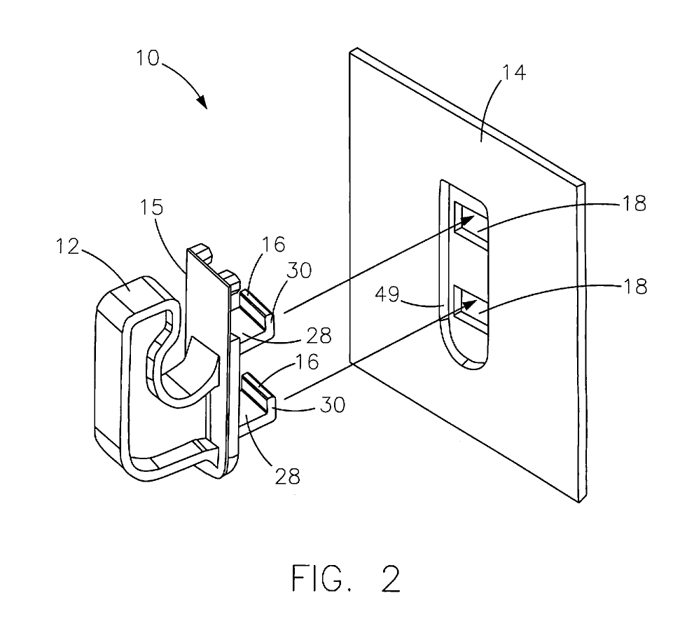

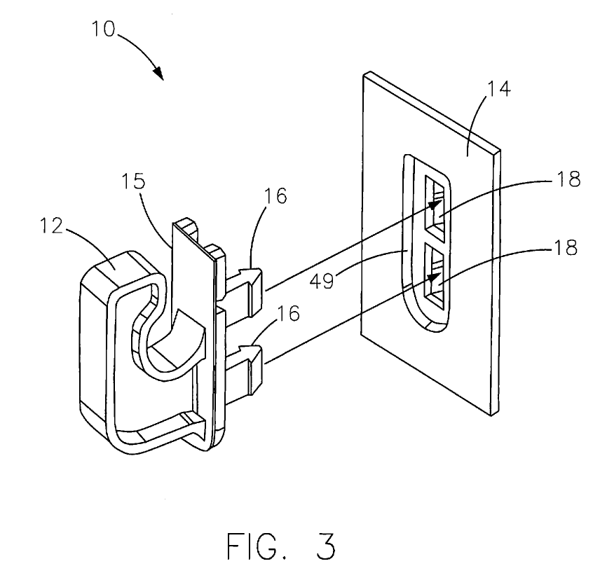

Referring to FIG. 1, the prongs 16 are T-shaped prongs defined by a wider head portion 20 and a narrower body portion 22. The corresponding keyhole-slot shaped apertures 18 have a wider receiving portion 24 and a narrower receiving portion 26. The apertures 18 are configured to receive the T-shaped prongs 16. During attachment of the accessory 12 to the vehicle panel 14, the T-shaped prongs 16 are passed through the apertures 18 and moved laterally to mate the accessory 12 with the vehicle panel 14, the head portion 20 entering the wider receiving portion 24 and the body portion 22 sliding down into the narrow receiving portion 26. In FIG. 2, the prongs 16 are L-shaped prongs defined by a longer body portion 28 extending into a shorter lip portion 30. The corresponding apertures 18 are rectangular and configured to receive the L-shaped prongs 16. During attachment of the accessory 12 to the vehicle panel 14, the L-shaped prongs 16 are passed through the apertures 18 and moved laterally to mate the accessory 12 with the vehicle panel 14. In FIG. 3, the prongs 16 have tapered ends and the corresponding apertures 18 have tapered sidewalls to form a frictional fit with the tapered prongs 16. During attachment, the tapered prongs 16 are configured to frictionally engage the tapered sidewalls of the apertures 18 to mate the accessory 12 with the vehicle panel 14. The male connector 16 and corresponding female connector 18 may have a number of different configurations including pegboard-type apertures and attachment members and other known attachment and receiving means known in the art. The female connector 18 may include a power and ground supply so that electrically powered accessories will work in select locations within the vehicle. The electrical system of the vehicle may provide an electrical connection to the female connector 18 which supplies electrical power to an accessory 12.

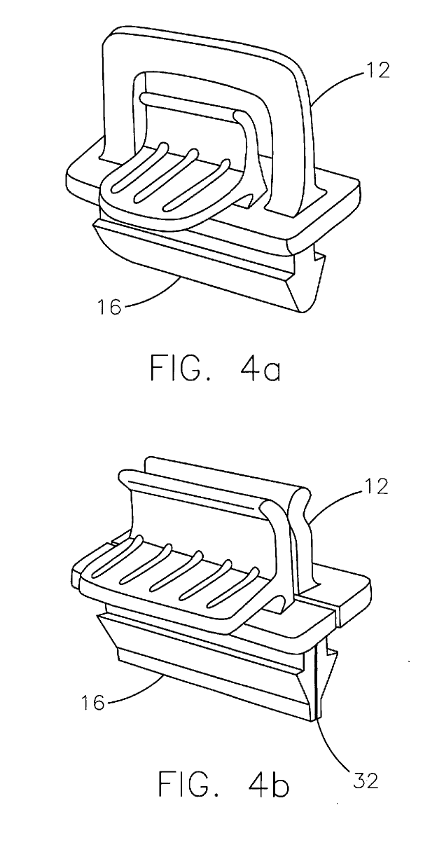

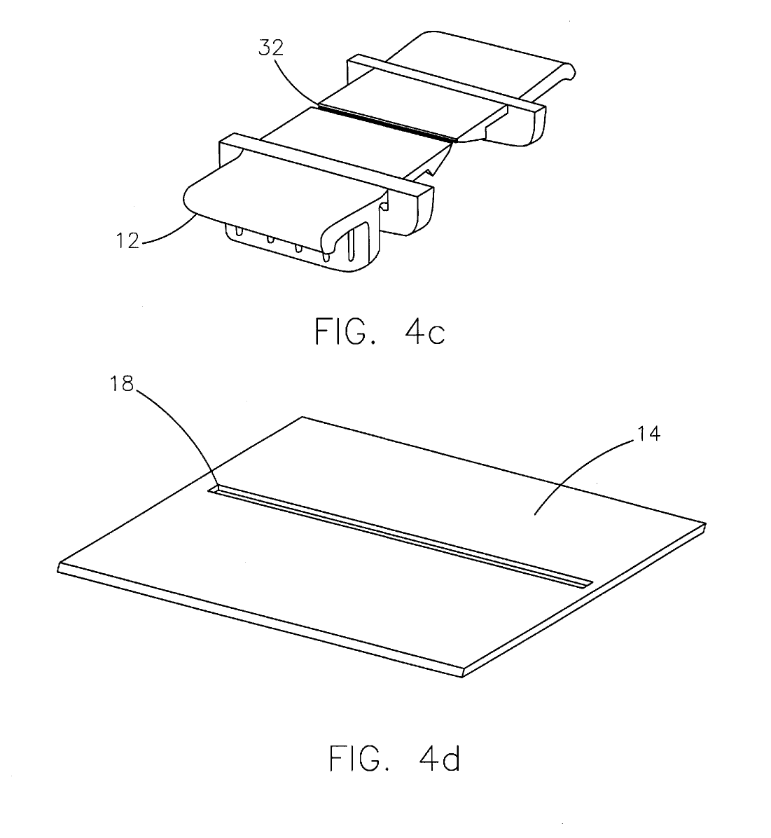

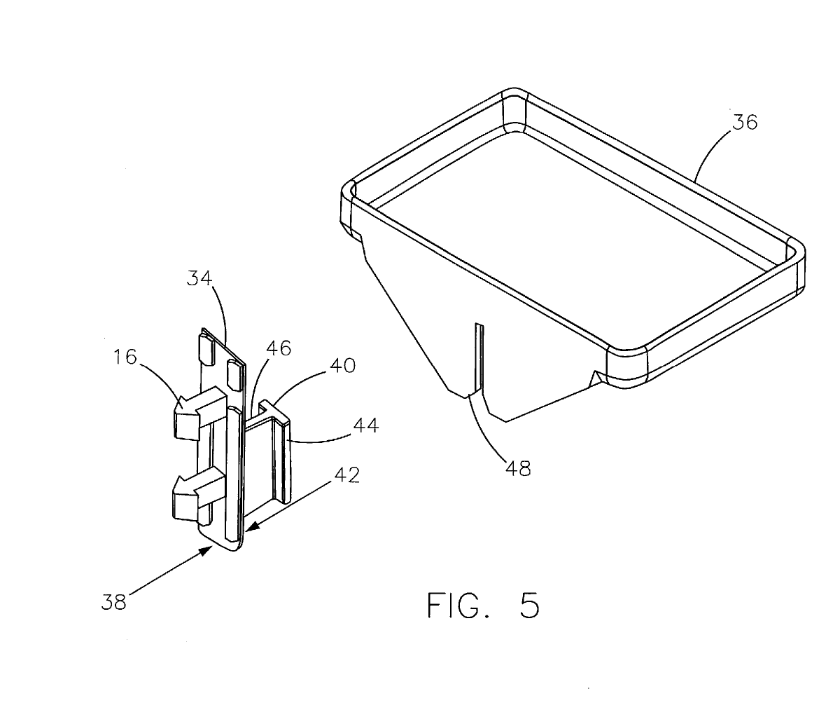

A further alternative configuration for the male connector 16 and the female connector 18 is shown in FIGS. 4a-d. The accessory 12 in FIGS. 4a-c is a card holder insert clip having a male connector in the form of an elongated tab 16 having a tapered end. In FIGS. 4b-c, the card holder insert clip comprises two pieces connected by a living hinge 32, forming a butterfly part. The accessory 12 is brought to its functional form by folding the two pieces of the butterfly part against one another, the tapered elongated tab 16 being formed along the living hinge 32. FIG. 4d illustrates a corresponding female connector 18 formed within a vehicle panel 14. The female connector is an elongated slot 18 having tapered side walls configured to receive the tapered elongated tab 16, whereby the tapered elongated tab 16 frictionally engages the tapered side walls of the elongated slot 18 to mate the accessory 12 with the vehicle panel 14.

Referring now to FIG. 5, the accessory may be an intermediate mounting member 34 adapted to selectively attach to a vehicle panel 14 and configured to mount a sub-accessory 36 (i.e., hook, tray, cup holder, sunglass holder, etc.) within the vehicle. The intermediate mounting member 34 includes a male connector 16 on the vehicle attachment side 38 and an intermediate connector 40 on the accessory attachment side 42. Like the accessories illustrated in FIGS. 1-4, the male connector 16 of the intermediate mounting connector 34 may take many forms, including but not limited to T-shaped prongs, an elongated T-shaped tab, L-shaped prongs, tapered tabs, and an elongated tapered tab. FIG. 5 shows the male connector in the form of a pair of tapered tabs 16 configured to frictionally engage a correspondingly shaped female connector 18 within the vehicle panel 14. The intermediate connector 40 is a male connector and may take many forms, including but not limited to T-shaped prongs, an elongated T-shaped tab, L-shaped prongs, tapered tabs, and an elongated tapered tab. FIG. 5 shows the intermediate connector in the form of an elongated T-shaped tab 40 having a head portion 44 and a body portion 46. The sub-accessory 36 includes a mounting connector 48 configured to mate with the intermediate connector 40 of the intermediate mounting member 34 to mount the sub-accessory 36 to the intermediate mounting member 34. The mounting connector 48 is a female connector and may take many forms, including but not limited to circular or rectangular apertures, a keyhole-shaped aperture having a wider receiving portion and a narrower receiving portion (FIG. 1), an aperture having tapered side walls, and an elongated slot. FIG. 5 shows the mounting connector in the form of an elongated slot 48. The elongated slot 48 is configured to receive the elongated T-shaped tab 40 to mount the sub-accessory 36 to the intermediate mounting member 34 and thus attach the sub-accessory 36 to the vehicle panel 14. During mounting of the sub-accessory 36, the elongated slot 48 receives the T-shaped tab 40, the body portion 46 sliding within the elongated slot 48, to mate the sub-accessory 36 with the intermediate mounting member 34. The male connector 16 of the intermediate mounting member 34 cooperates with a female connector 18 within a vehicle panel 14 to attach the intermediate mounting member 34 and mounted sub-accessory 36 to the vehicle panel 14. Thus, the intermediate mounting member 34, having a male connector on both the vehicle attachment side 38 and the accessory attachment side 42, may be used to mate accessories having a female connector (as opposed to a male connector) with the female connector 18 defined by the vehicle panel 14.

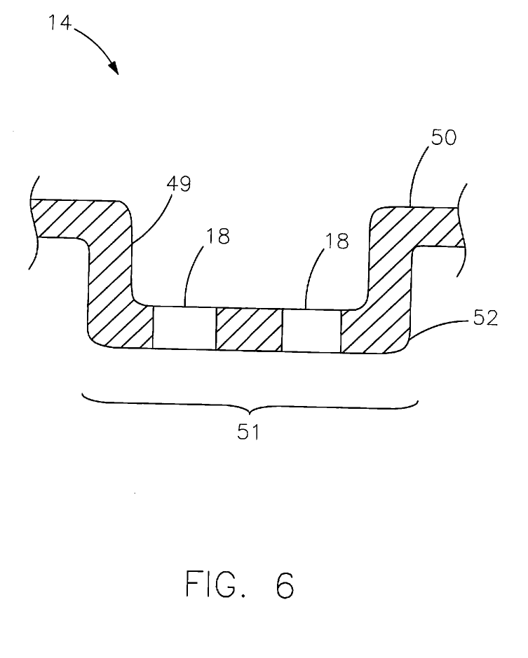

The female connector 18 may be formed within a vehicle panel 14 during the manufacturing process. For instance, where the vehicle panel 14 is formed through an injection molding process, the female connector 18, including but not limited to the apertures and slots illustrated in FIGS. 1-4, may be formed within the vehicle panel 14 during the injection molding process. With reference to FIG. 6, the vehicle panel 14 includes a surface exposed to the interior of the vehicle, i.e., an A-surface 50. The vehicle panel 14 includes a recessed portion 51 defined by the A-surface 50 and surface 52 spaced apart from and generally parallel to the A-surface 50. The female connector, in the form of a pair of apertures 18, is formed within the recessed portion 51 of the vehicle panel 14. Hence, the female connector 18 may exist in a plane generally parallel to the first surface. As many vehicle panels 14 are contoured or curved panels, a plane should not be limited to a flat, planar surface, but rather should encompass contoured or curved surfaces. A blanking plug may be provided as an accessory to mask the apertures 18 when the accessory 12 is not attached to the vehicle panel 14. During attachment, the accessory 12 or a blanking plug fits within the recessed portion, engaging its side walls 49.

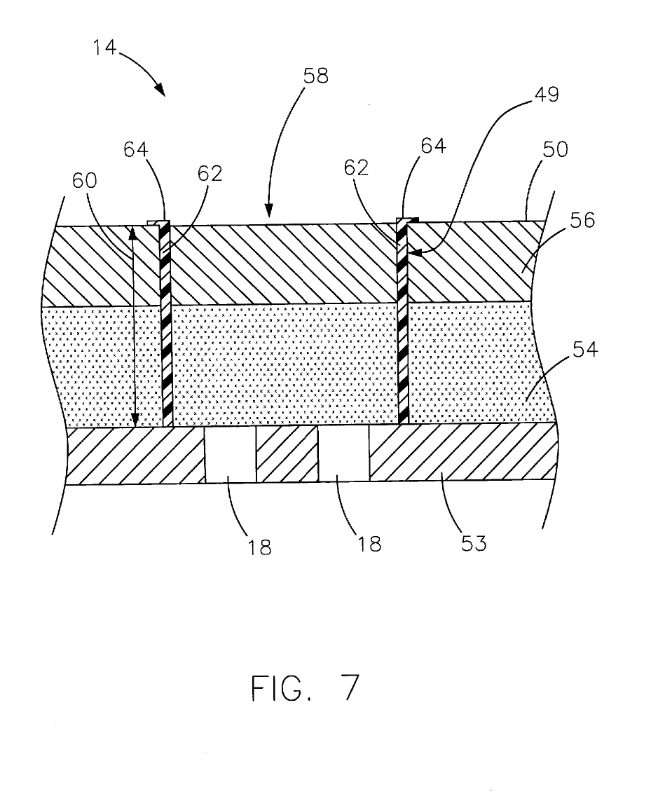

Referring to FIG. 7, an alternative embodiment of a vehicle panel is illustrated. The vehicle panel 14, for example a door panel, typically has a number of layers including an inner substrate layer 53, a foam layer 54, and an outer skin layer 56 which defines the A-surface 50. The skin layer 56 may be made of a thermoplastic polymer material or any other suitable material known to those of ordinary skill in the art. The area of the skin layer 56 and the foam layer 54 mounted on the substrate layer 53 may be cut out as part of the manufacturing process, or may be milled out at a dealership, forming a recessed portion and exposing the substrate layer 53 through which the female connector, in the form of a pair of apertures 18, is formed. The recessed portion includes side walls 49 having a height or depth 60 equal to the thickness of the foam layer plus the thickness of the skin layer. In other words, the recessed portion 51 has a depth 60 defined by the distance between the A-surface 50 and the substrate layer 53. The apertures 18 are formed within the substrate layer 53 during the manufacturing process. If the skin layer 56 and the foam layer 54 are cut out as part of the manufacturing process, a blanking plug 58 comprising the same materials (i.e., a skin layer 56 and a foam layer 54) may be provided as an accessory to mask the apertures 18 when the accessory 12 is not attached to the vehicle panel 14.

Alternatively, if the skin layer 56 and foam layer 54 are milled out at a dealership, the vehicle panel 14 may include seams or stitching to designate where the skin and foam layers 56, 54 should be milled out to appropriately unmask the apertures 18 when the accessory 12 is to be attached to the vehicle panel 14. The area of skin and foam layers 56, 54 that is milled out may act as a blanking plug 58 to mask the apertures 18 after removal of the accessory 12. The routing process for milling out the skin and foam layers 56, 54 at the dealership may create sharp or jagged edges where the cut is made. A decorative flange 62 may be provided to conceal the sharp edges formed by the cut and provide a smooth surface along the perimeter of the recessed portion 51. The decorative flange 62 may be made of a plastic material or any other suitable material known to those of ordinary skill in the art. The decorative flange 62 engages the side walls 49 within the recessed portion and has an upper lip portion 64 which extends along the A-surface 50. During attachment, the accessory 12 or the blanking plug 58 fits within the recessed portion, engaging the decorative flange 62.

The recessed portion 51 including the female connector 18 of a vehicle panel 14 may take the form shown in the figures, but may take any form that allows selective attachment and removal of an accessory 12 having a male connector 16 designed to cooperate with the female connector 18. Since many vehicle panels 14 are defined by contoured surfaces, the recessed portion 51 and/or female connector 18 within the contoured vehicle panel 14 may have a contour matching that of the contoured vehicle panel 14. The male connector 16 of the accessory 12 is adapted to be selectively attached to any given female connector 18 within any given recessed portion 51, whether it is contoured or flat. For example, the accessory 12 may have a base plate 15, to which the male connector 16 is attached, formed of a flexible material, allowing the accessory 12 to be selectively attached to both flat and contoured vehicle panels 14.

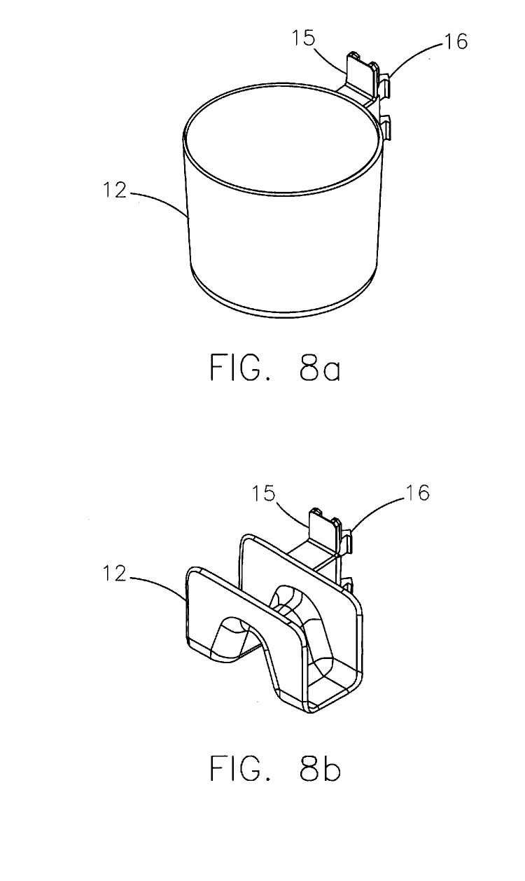

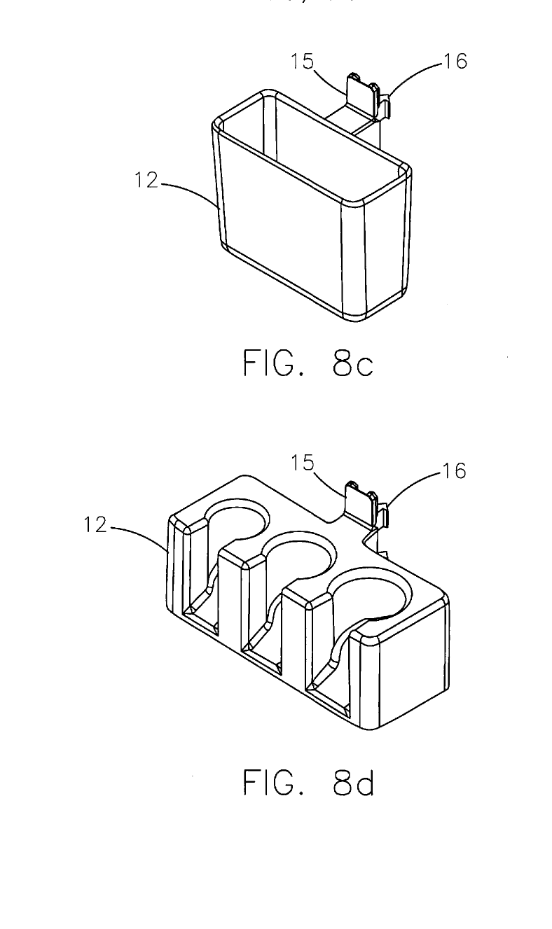

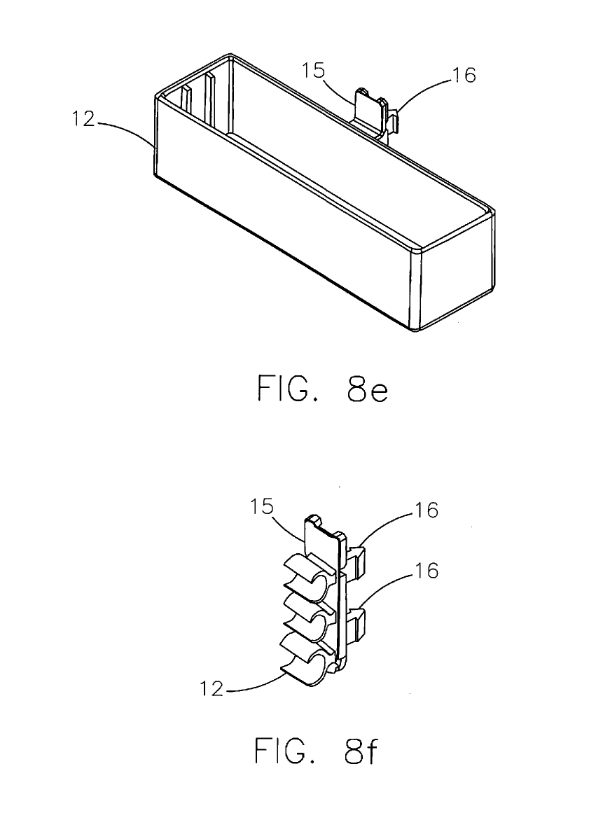

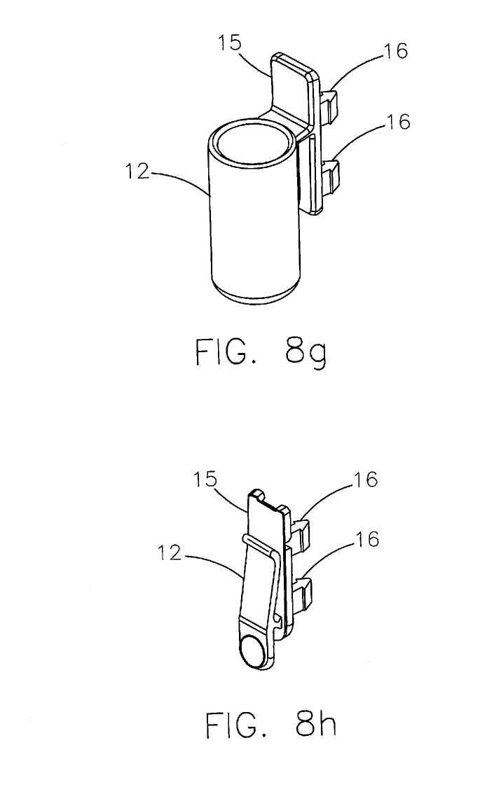

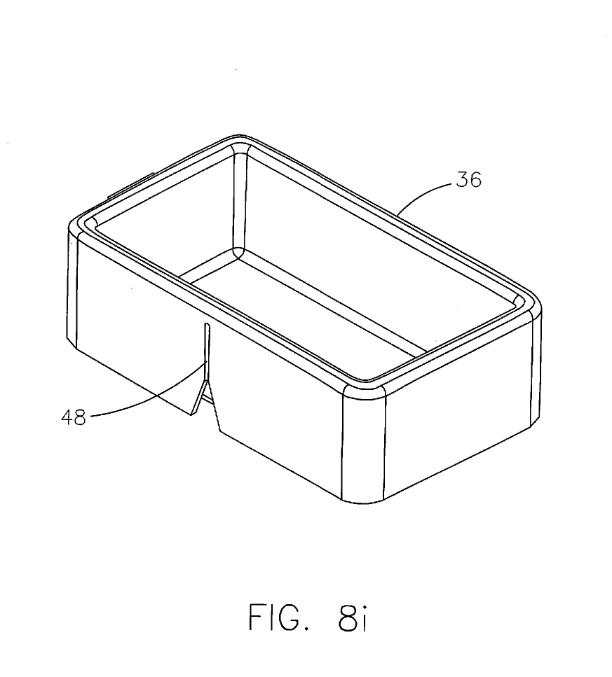

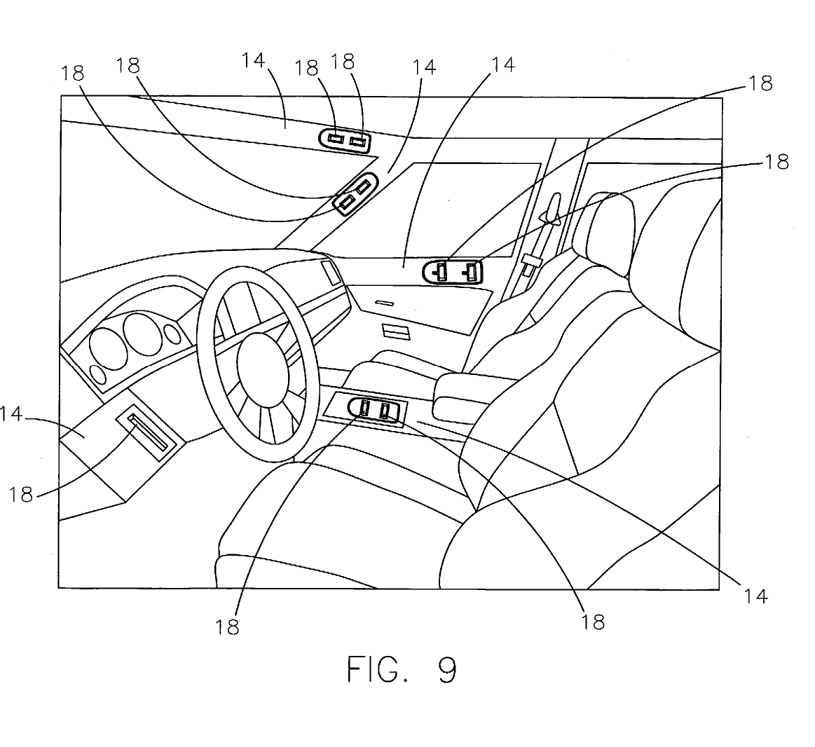

The accessory attachment system 10 is thus universally and flexibly designed to attach a variety of different accessories 12 to various vehicle panels 14 the interior of a vehicle. The variety of accessories 12 may include a hook (FIGS. 1-3), a card holder (FIGS. 4a-c, 8h), a tray (FIG. 5), a cup holder (FIG. 8a), a sunglass holder (FIG. 8b), a phone holder (FIG. 8c), a coin holder (FIG. 8d), a CD or DVD holder (FIG. 8e), a pencil or pen holder (FIG. 8f), a lipstick holder (FIG. 8g), a trash or tissue box holder (FIG. 8i), and the like. The various vehicle panels 14 to which the accessories 12 selectively attach may include an instrument panel, a center stack console, a pillar trim panel (i.e., A-pillar, B-pillar, etc.), a ceiling panel, a door panel, a package tray, a seat back, a trunk panel, and the like. FIG. 9 illustrates various vehicle panels 14 having alternative embodiments of female connectors 18 formed within. An accessory 12 having a male connector 16 configured to cooperate with the female connector 18 formed integrally with the vehicle panel 14 allows direct attachment of the accessory 12 to the vehicle panel 14. The present invention thus provides a flexible and cost-effective accessory attachment system 10 in which consumers may customize accessories within their vehicle to fit personal preferences and in which the accessories may be interchangeable with other vehicles incorporating the same invention.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. An accessory attachment system for the interior of a vehicle comprising:
an accessory having a male connector adapted to attach the accessory to a vehicle panel located within the interior of the vehicle,
the vehicle panel defining a female connector sized and shaped to receive the male connector,
the male connector cooperating with the female connector to selectively attach the accessory within the vehicle interior.

2. The system of claim 1, wherein the vehicle panel includes a first surface exposed to the interior of the vehicle, the female connector being formed within the first surface.

3. The system of claim 1, wherein the vehicle panel includes a first surface exposed to the interior of the vehicle, the female connector being formed in a plane generally parallel to the first surface.

4. The system of claim 3, wherein the vehicle panel is a curved vehicle panel, wherein the plane generally parallel to the first surface includes a curved plane.

5. The system of claim 1, wherein the vehicle panel includes a first surface exposed to the interior of the vehicle and a second surface generally parallel to the first surface, the female connector being formed within the second surface.

6. The system of claim 5, wherein the second surface is spaced apart from the first surface defining a recessed portion of the vehicle panel, the female connector being formed within the recessed portion.

7. The system of claim 6, wherein the first surface is an outer layer mounted on a substrate, the substrate defining the second surface.

8. The system of claim 7, further comprising a plug for masking the female connector when the accessory is not attached to the vehicle panel, wherein the plug is configured to be received within the recessed portion.

9. The system of claim 8, wherein the recessed portion includes a side wall, the system further comprising a flange having an upper lip portion, wherein the flange engages the side wall, the upper lip portion extending over the first surface, wherein the flange provides a smooth surface within the recessed portion for receiving the plug.

10. The system of claim 1, wherein the female connector is formed during the manufacturing process of the vehicle panel.

11. The system of claim 1, wherein the male connector includes an L-shaped prong, wherein the female connector includes an aperture configured to receive the L-shaped prong, whereby the L-shaped prong extends through the aperture to mate the male connector with the female connector when the accessory is selectively attached to the vehicle panel.

12. The system of claim 1, wherein the male connector includes a tab, wherein the female connector includes a slot configured to receive the tab, whereby the tab extends through the slot to mate the male connector with the female connector when the accessory is attached to the vehicle panel.

13. The system of claim 1, wherein the male connector includes a T-shaped prong, wherein the female connector includes an aperture having a wider portion and narrower portion to receive the T-shaped prong, whereby the T-shaped prong extends through the aperture to mate the male connector with the female connector when the accessory is selectively attached to the vehicle panel.

14. The system of claim 1, wherein the accessory is an intermediate mounting member, the intermediate mounting member having an intermediate connector, the system further comprising a second accessory having a mounting connector attachable to the intermediate connector.

15. The system of claim 14, wherein the intermediate connector is a second male connector, wherein the mounting connector is a second female connector, whereby the second male connector cooperates with the second female connector to selectively attach the second accessory to the intermediate mounting member.

16. The system of claim 1, wherein the accessory includes at least one of an intermediate mounting member, a hook, a tray, a cup holder, a card holder, a coin holder, a sunglass holder, a phone holder, a CD or DVD holder, a pencil or pen holder, a lipstick holder, and a tissue box holder.

17. The system of claim 1, wherein the vehicle panel includes at least one of an instrument panel, a center stack console, a pillar trim panel, a ceiling panel, a door panel, a package tray, a seat back, and a trunk panel.

18. The system of claim 1, further comprising a plurality of accessories, each accessory having a male connector adapted to attach each accessory to the vehicle panel, the vehicle panel defining a plurality of female connectors sized and shaped to receive the male connectors.

19. An accessory attachment system for the interior of a vehicle comprising:
an accessory having a male connector adapted to attach the accessory to a vehicle panel located within the interior of the vehicle, the vehicle panel having a first surface exposed to the interior of the vehicle; and
a plurality of female connectors formed within the vehicle panel such that the accessory attaches directly to the vehicle panel, each female connector being sized and shaped to receive the male connector, whereby the male connector cooperates with the female connector to selectively attach the accessory within the vehicle.

20. The system of claim 19, wherein the vehicle panel defines a second surface spaced apart from the first surface to define a recessed portion of the vehicle panel, and wherein at least one female connector is formed within the recessed portion.
